(19) United States
(12) Patent Application Publication
(10) Pub. No.: US 2023/0134803 A1
(43) Pub. Date: May 4, 2023

(54) BEAM HOPPING FOR REPETITIONS IN A PHYSICAL UPLINK CONTROL CHANNEL RESOURCE

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Fang YUAN, Beijing (CN); Tao LUO, San Diego, CA (US)

(21) Appl. No.: 17/905,898

(22) PCT Filed: Mar. 9, 2020
(86) PCT No.: PCT/CN2020/078362

§ 371 Date: Sep. 8, 2022

(51) Int. Cl. H04W 16/28; H04W 52/36; H04W 52/24

(52) U.S. Cl. CPC H04W 16/28; H04W 52/367; H04W 52/242

(57) ABSTRACT

Various aspects of the present disclosure generally relate to wireless communication. In some aspects, a user equipment (UE) may receive an activation command to activate multiple spatial relations for a physical uplink control channel (PUCCH) resource that is to be used for transmitting repetitions of a communication in multiple slots. The UE may transmit the repetitions in the PUCCH resource in the multiple slots using the multiple spatial relations. Numerous other aspects are provided.

### FIELD OF THE DISCLOSURE

Aspects of the present disclosure generally relate to wireless communication and to techniques and apparatuses for beam hopping for repetitions in a physical uplink control channel resource.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving an activation command to activate multiple spatial relations for a physical uplink control channel (PUCCH) resource that is to be used for transmitting repetitions of a communication in multiple slots; and transmitting the repetitions in the PUCCH resource in the multiple slots using the multiple spatial relations.

In some aspects, a method of wireless communication, performed by a base station (BS), may include determining, for a UE, multiple spatial relations that are to be activated for a PUCCH resource that is to be used by the UE for transmitting repetitions of a communication in multiple slots; and transmitting an activation command to the UE to activate the multiple spatial relations for the PUCCH resource.

In some aspects, a UE for wireless communication may include a memory and one or more processors operatively coupled to the memory. The memory and the one or more processors may be configured to receive an activation command to activate multiple spatial relations for a PUCCH resource that is to be used for transmitting repetitions of a communication in multiple slots; and transmit the repetitions in the PUCCH resource in the multiple slots using the multiple spatial relations.

In some aspects, a BS for wireless communication may include a memory and one or more processors operatively coupled to the memory. The memory and the one or more processors may be configured to determine, for a UE, multiple spatial relations that are to be activated for a PUCCH resource that is to be used by the UE for transmitting repetitions of a communication in multiple slots; and transmit an activation command to the UE to activate the multiple spatial relations for the PUCCH resource.

In some aspects, a non-transitory computer-readable medium may store one or more instructions for wireless communication. The one or more instructions, when executed by one or more processors of a UE, may cause the one or more processors to receive an activation command to activate multiple spatial relations for a PUCCH resource that is to be used for transmitting repetitions of a communication in multiple slots; and transmit the repetitions in the PUCCH resource in the multiple slots using the multiple spatial relations.

In some aspects, a non-transitory computer-readable medium may store one or more instructions for wireless communication. The one or more instructions, when executed by one or more processors of a BS, may cause the one or more processors to determine, for a UE, multiple spatial relations that are to be activated for a PUCCH resource that is to be used by the UE for transmitting repetitions of a communication in multiple slots; and transmit an activation command to the UE to activate the multiple spatial relations for the PUCCH resource.

In some aspects, an apparatus for wireless communication may include means for receiving an activation command to activate multiple spatial relations for a PUCCH resource that is to be used for transmitting repetitions of a communication in multiple slots; and means for transmitting the repetitions in the PUCCH resource in the multiple slots using the multiple spatial relations.

In some aspects, an apparatus for wireless communication may include means for determining, for a UE, multiple spatial relations that are to be activated for a PUCCH resource that is to be used by the UE for transmitting repetitions of a communication in multiple slots; and means for transmitting an activation command to the UE to activate the multiple spatial relations for the PUCCH resource.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station (BS) in communication with a user equipment (UE) in a wireless communication network, in accordance with various aspects of the present disclosure.

FIGS. 3A-7 are diagrams illustrating one or more examples of beam hopping for repetitions in a physical uplink control channel resource, in accordance with various aspects of the present disclosure.

FIG. 8 is a diagram illustrating an example process performed, for example, by a UE, in accordance with various aspects of the present disclosure.

FIG. 9 is a diagram illustrating an example process performed, for example, by a BS, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

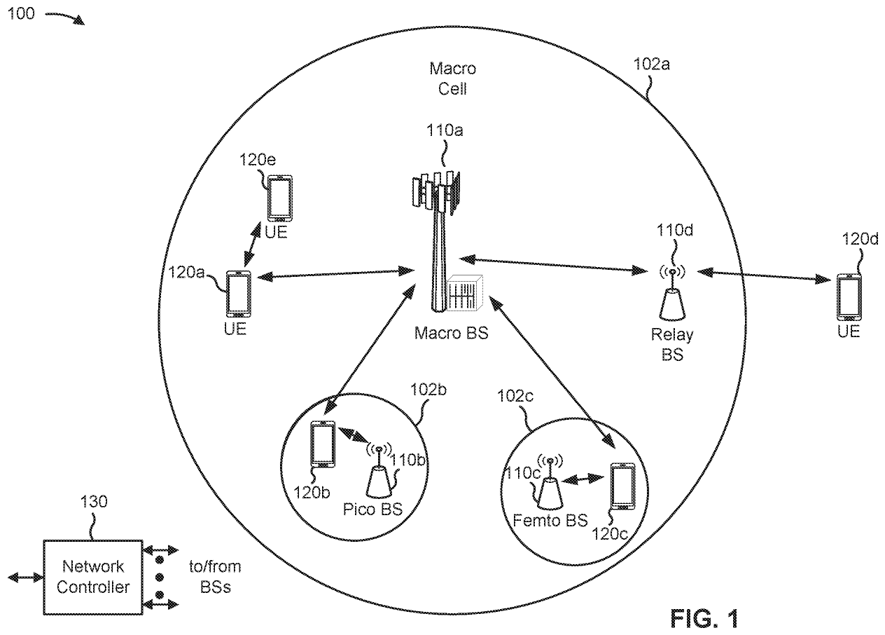

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of base stations (BSs) 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

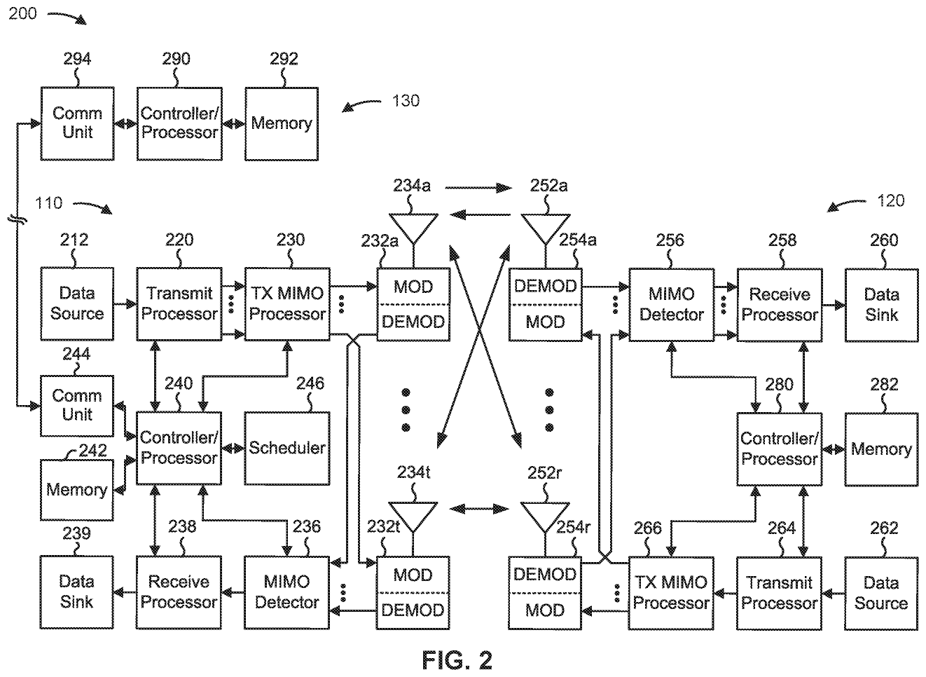

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MC S(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

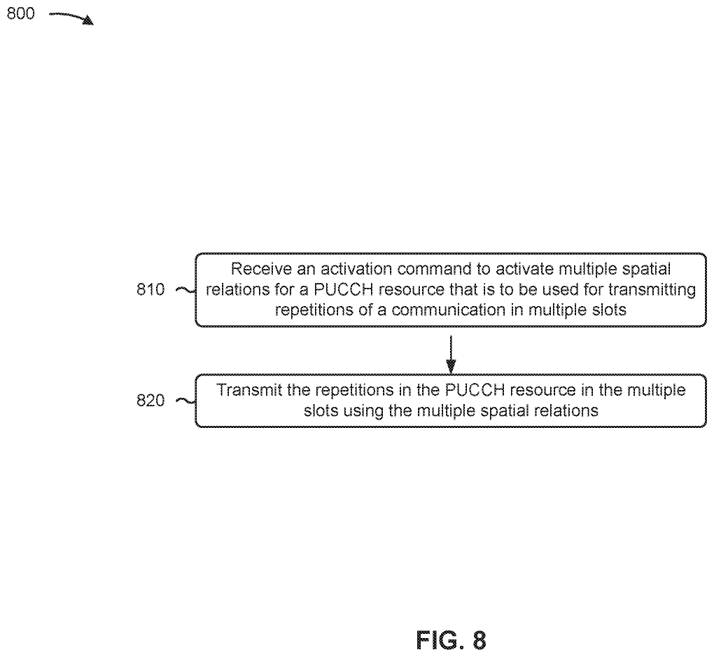

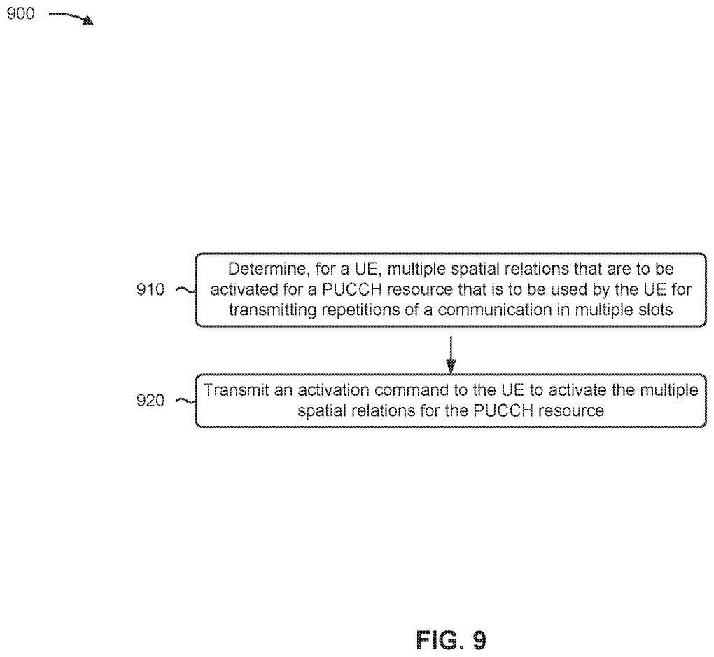

Controller/processor 240 of base station 110, controller/processor 280 of UE 120, and/or any other component(s) of FIG. 2 may perform one or more techniques associated with beam hopping for repetitions in a physical uplink control channel (PUCCH) resource, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 800 of FIG. 8, process 900 of FIG. 9, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, UE 120 may include means for receiving an activation command to activate multiple spatial relations for a PUCCH resource that is to be used for transmitting repetitions of a communication in multiple slots, means for transmitting the repetitions in the PUCCH resource in the multiple slots using the multiple spatial relations, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining, for a UE, multiple spatial relations that are to be activated for a PUCCH resource that is to be used by the UE for transmitting repetitions of a communication in multiple slots, means for transmitting an activation command to the UE to activate the multiple spatial relations for the PUCCH resource, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

Wireless communication devices, such as UEs, BSs, TRPs, and/or the like, may communicate with each other using beams. In some cases, a beam indication (e.g., a transmission configuration indication (TCI) state, a quasi-co-location (QCL) relationship, a spatial relation, and/or the like) may be separately signaled for different resources. For example, for uplink communications, a BS may indicate a set of spatial relations (e.g., a set of eight spatial relations) that are to be used for different PUCCH resources. Moreover, the BS may signal an activated spatial relation for a particular PUCCH resource. For example, the BS may signal a first activated spatial relation for a first PUCCH resource, a second activated spatial relation for a second PUCCH resource, and so forth.

In some cases, it may be beneficial for a UE to communicate using multiple beams that are to be received by different receivers (e.g., different antennas, panels, TRPs, BSs, and/or the like), thereby improving performance of the UE's communications. However, a UE may not be enabled to communicate using multiple beams for repetitions of a communication that are to be transmitted in a PUCCH resource in multiple slots. As a result, a diversity and/or a reliability of communications may be impaired. Some techniques and apparatuses described herein enable a UE to communicate using multiple beams for repetitions that are to be transmitted in a PUCCH resource in multiple slots.

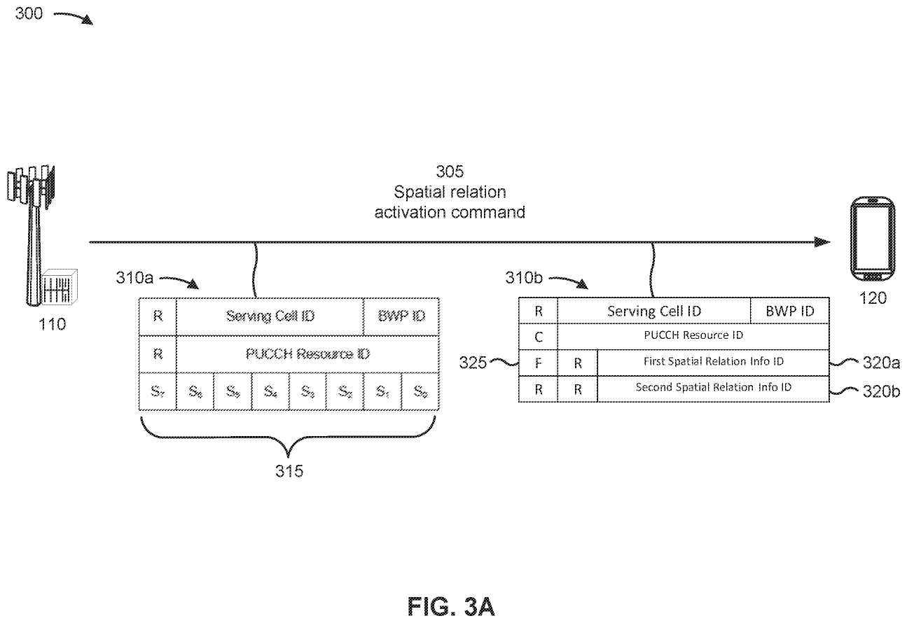

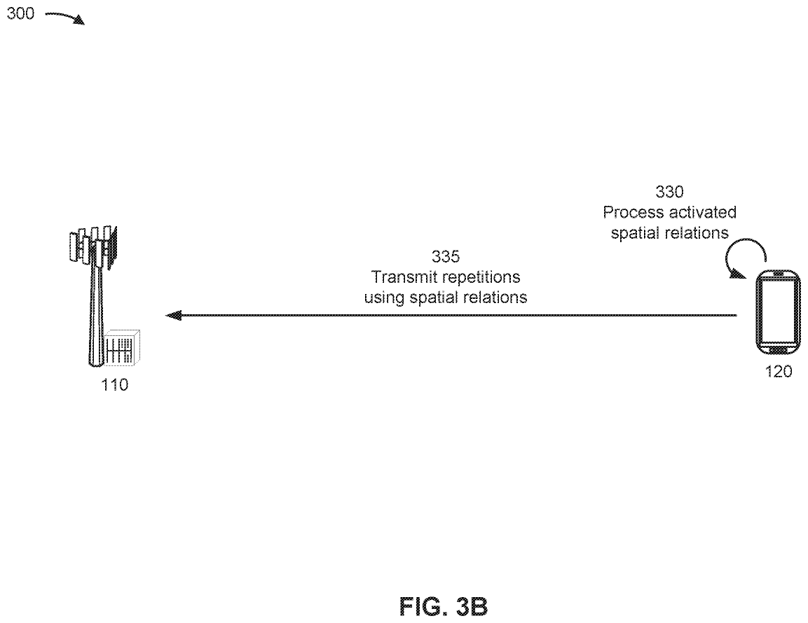

FIGS. 3A and 3B are diagrams illustrating one or more examples 300 of beam hopping for repetitions in a PUCCH resource, in accordance with various aspects of the present disclosure. As shown in FIGS. 3A and 3B, a BS 110 and a UE 120 may communicate with one another.

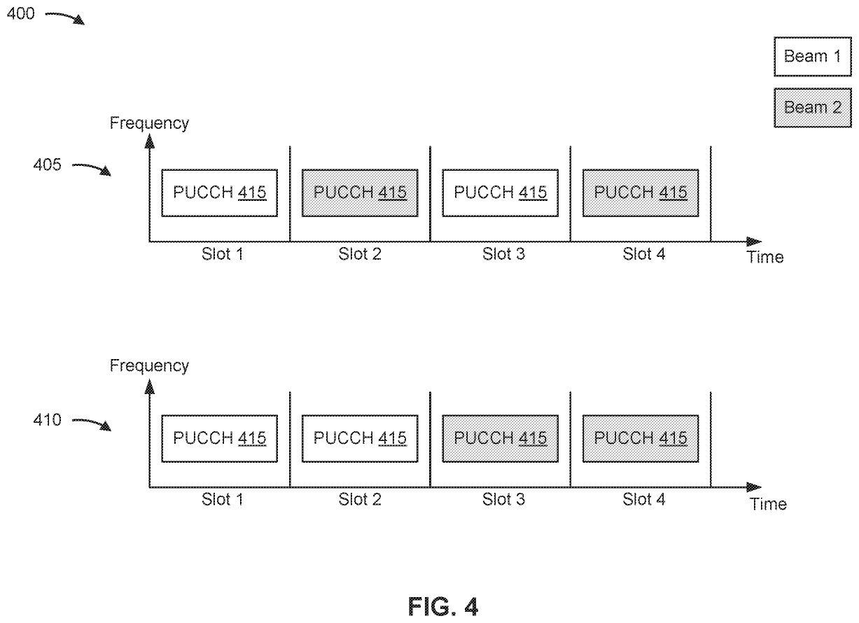

As shown in FIG. 3A, and by reference number 305, the BS 110 may transmit, and the UE 120 may receive, an activation command to activate multiple (e.g., two) spatial relations for a PUCCH resource (e.g., PUCCH resource 415, as described in connection with FIGS. 4-7) that is to be used for transmitting repetitions of a PUCCH communication in multiple slots (e.g., the PUCCH resource may be configured with a quantity of repetitions (using a PUCCH format nrofSlots parameter) that is greater than one). That is, the BS 110 may determine, for the UE, multiple spatial relations that are to be activated for the PUCCH resource, and transmit an activation command to activate the multiple spatial relations. The activation command may be included in a medium access control control element (MAC-CE), such as MAC-CE 310a or MAC-CE 310b. For example, the MAC-CE may include the activation command by identifying spatial relation identifiers (e.g., PUCCH-SpatialRelationlnfolds) of the multiple spatial relations that are to be activated.

The MAC-CE may also identify the PUCCH resource, such as by a PUCCH resource identifier, for which the multiple spatial relations are to be activated. A spatial relation (e.g., spatial relation information) may identify a serving cell, a reference signal (e.g., a synchronization signal block (SSB), a channel state information reference signal (CSI-RS), a sounding reference signal (SRS), and/or the like), power control parameters (e.g., a PUCCH pathloss reference signal (PL-RS), a power control offset value (referred to as a PO parameter), a closed loop index, and/or the like), and/or the like.

In some aspects, the MAC-CE 310a may include a bitmap 315 for spatial relations. Bits (shown as S₀-S₇) of the bitmap 315 may map to spatial relations configured for the UE 120. For example, a first bit (e.g., S₀) of the bitmap 315 maps to a first spatial relation configured for the UE 120, a second bit (e.g., Si) of the bitmap 315 maps to a second spatial relation configured for the UE 120, and so forth. In this example, multiple bits (e.g., two bits) of the bitmap 315 may be set to indicate the spatial relations that are to be activated (e.g., according to the mapping of bits to spatial relations). A bit that is set may have a value of one, and a bit that is not set may have a value of zero.

In some aspects, the MAC-CE 310b may include multiple fields to indicate the multiple spatial relations. For example, the MAC-CE 310b may include a first field 320a to indicate a first spatial relation that is to be activated and a second field 320b to indicate a second spatial relation that is to be activated. In some aspects, the MAC-CE 310b may include additional fields to indicate additional spatial relations that are to be activated. In some aspects, the MAC-CE 310b may include a flag 325 to indicate whether the second field 320b is present in the MAC-CE 310b. For example, the flag 325 may be set (e.g., to a value of one) to indicate that the second field 320b is present in the MAC-CE 310b.

The activated spatial relations may be associated with respective sets of the repetitions that are to be transmitted in the PUCCH resource. For example, a first activated spatial relation may be associated with a first set of repetitions (that are to be transmitted in a first set of slots), and a second activated spatial relation may be associated with a second set of repetitions (that are to be transmitted in a second set of slots). In other words, the first activated spatial relation may indicate a first beam (e.g., Beam 1, as described in connection with FIGS. 4-7) that is to be used for the first set of repetitions, and the second activated spatial relation may indicate a second beam (e.g., Beam 2, as described in connection with FIGS. 4-7) that is to be used for the second set of repetitions.

As shown in FIG. 3B, and by reference number 330, the UE 120 may perform processing in connection with the activated spatial relations. In some aspects, the UE 120 may determine that the first set of repetitions are to use the same spatial domain filter that the UE 120 used for reception of a reference signal (e.g., an SSB, a CSI-RS, and/or the like), or transmission of a reference signal (e.g., an SRS), indicated by the first activated spatial relation, and that the second set of repetitions are to use the same spatial domain filter that the UE 120 used for reception of a reference signal, or transmission of a reference signal, indicated by the second activated spatial relation. In some aspects, the UE 120 may determine that the first set of repetitions are to use a first set of power control parameters (e.g., a pathloss reference signal (PL-RS), a PO parameter, a closed loop index, and/or the like) indicated by the first activated spatial relation, and that the second set of repetitions are to use a second set of power control parameters indicated by the second activated spatial relation.

In some aspects, the UE 120 may determine a first PUCCH power value that is to be used for the first set of repetitions, and a second PUCCH power value that is to be used for the second set of repetitions. In some aspects, the UE 120 may determine a PUCCH power value according to Equation 1 (as detailed in 3GPP Technical Specification 38.213, Section 7.2.1):

$$\text{?} = min \{ \begin{matrix}\text{?} \\ \text{?} + 10 {log}_{10} ( \text{?} ) + \text{?}\end{matrix} \} \\ [ dBm ] \qquad Equation 1$$

$$\text{?} \text{indicates text missing or illegible when filed}$$

The UE 120 may determine the first PUCCH power value for the first set of repetitions based at least in part on power control parameters (e.g., a PL-RS, a PO parameter, and/or a closed loop index) indicated by the first spatial relation, and a second PUCCH power value for the second set of repetitions based at least in part on power control parameters indicated by the second spatial relation.

In some aspects, respective closed loop indices indicated by the first spatial relation and the second spatial relation may be different. In this case, to determine the first PUCCH power value, the UE 120 may determine a first transmit power control (TPC) accumulation function value (i.e., g_{b,f,x}(i,l)) based at least in part on a first closed loop index indicated by the first spatial relation. To determine the second PUCCH power value, the UE 120 may determine a second TPC accumulation function value based at least in part on a second closed loop index indicated by the second spatial relation.

Moreover, downlink control information (DCI), that schedules a physical downlink shared channel (PDSCH) communication and a transmission of UCI (e.g., acknowledgment feedback for the PDSCH communication) in the PUCCH resource, may indicate a TPC command (e.g., a value from 0 to 3). The TPC command may map to a particular power adjustment that is to be used for determining a TPC accumulation function value. Accordingly, the UE 120 may apply the TPC command to the first closed loop index (when determining the first TPC accumulation function value), the second closed loop index (when determining the second TPC accumulation function value), or both the first and second closed loop indices (when determining the first and second TPC accumulation function values). In some aspects, the DCI may indicate respective TPC commands for the first closed loop index and the second closed loop index, and the UE 120 may determine the first and second TPC accumulation function values based at least in part on the respective TPC commands. For example, multiple TPC commands may be indicated in respective TPC fields of the DCI, or a single TPC field of the DCI may indicate the multiple TPC commands.

As shown by reference number 335, the UE 120 may transmit, and the BS 110 may receive, the repetitions using the multiple spatial relations. The UE 120 may transmit a repetition in an occasion of the PUCCH resource of a slot. For example, the UE 120 may transmit a first repetition in a first occasion of the PUCCH resource in a first slot, a second repetition in a second occasion of the PUCCH resource in a second slot, and so forth. The repetitions may be of a PUCCH communication (e.g., UCI, such as hybrid automatic repeat request acknowledgment (HARQ-ACK) feedback, channel state information, and/or the like).

In some aspects, the UE 120 may transmit the first set of repetitions using a first beam (as indicated by the first activated spatial relation), and the second set of repetitions using a second beam (as indicated by the second activated spatial relation). The UE 120 may transmit the first set of repetitions in a first set of slots, and the second set of repetitions in a second set of slots, as described below in connection with FIGS. 4-7. In some aspects, the first set of repetitions (transmitted using a first beam) may be received by a first receiver (e.g., a first antenna, panel, TRP, BS, and/or the like), and the second set of repetitions (transmitting using a second beam) may be received by a second receiver (e.g., a second antenna, panel, TRP, BS, and/or the like).

In some aspects, the UE 120 may begin to transmit the repetitions using multiple beams upon receiving the MAC-CE (e.g., MAC-CE 310a or MAC-CE 310b) that includes the activation command for multiple spatial relations. For example, the UE 120 may apply the activation command after a time window (e.g., 3 milliseconds) after the UE 120 transmits acknowledgment feedback (e.g., HARQ-ACK feedback) for the PDSCH carrying the MAC-CE. Additionally, or alternatively, the UE 120 may begin to transmit the repetitions using multiple beams upon receiving a configuration (e.g., a radio resource control (RRC) configuration) for multiple beam hopping for the PUCCH resource in different slots (e.g., an RRC parameter interSlotBeamHopping is enabled).

As indicated above, FIGS. 3A and 3B are provided as one or more examples. Other examples may differ from what is described with respect to FIGS. 3A and 3B.

FIG. 4 is a diagram illustrating an example 400 of beam hopping for repetitions in a PUCCH resource, in accordance with various aspects of the present disclosure. In particular, FIG. 4 shows a beam hopping pattern 405 and a beam hopping pattern 410 for transmitting repetitions in a PUCCH resource 415 in multiple slots. In the example 400, four repetitions are configured for the PUCCH resource 415. However, in some aspects, a different quantity of repetitions may be configured for the PUCCH resource 415, such as two repetitions or eight repetitions.

As described above, a first set of repetitions may use the same spatial domain filter used for reception or transmission of a reference signal indicated by the first activated spatial relation, and a second set of repetitions may use the same spatial domain filter used for reception or transmission of a reference signal indicated by the second activated spatial relation. In other words, the UE 120 may transmit the first set of repetitions using a first beam (Beam 1), and the second set of repetitions using a second beam (Beam 2).

As shown by beam hopping pattern 405, the first set of repetitions (using Beam 1) and the second set of repetitions (using Beam 2) may be cyclically mapped to the PUCCH resource 415 in multiple slots. In other words, repetitions of the first set alternate with repetitions of the second set. For example, as shown, the UE 120 may transmit the first set of repetitions using Beam 1 in Slot 1 and Slot 3, and transmit the second set of repetitions using Beam 2 in Slot 2 and Slot 4. Stated another way, repetitions of the first set are even-indexed repetitions (e.g., repetition 0 and repetition 2), and repetitions of the second set are odd-indexed repetitions (e.g., repetition 1 and repetition 3). Alternatively, repetitions of the first set are odd-indexed repetitions, and repetitions of the second set are even-indexed repetitions.

As shown by beam hopping pattern 410, the first set of repetitions (using Beam 1) and the second set of repetitions (using Beam 2) may be sequentially mapped to the PUCCH resource 415 in multiple slots. In other words, repetitions of the first set are in consecutive slots, and repetitions of the second set are in consecutive slots. For example, as shown, the UE 120 may transmit the first set of repetitions using Beam 1 in Slot 1 and Slot 2, and transmit the second set of repetitions using Beam 2 in Slot 3 and Slot 4. Stated another way, repetitions of the first set occur before repetitions of the second set. Alternatively, repetitions of the second set occur before repetitions of the first set.

In some aspects, a pattern of repetitions of the first set and repetitions of the second set is indicated via RRC signaling. For example, the BS 110 may transmit, and the UE 120 may receive, an RRC configuration that indicates the pattern that the UE 120 is to use. The pattern may be beam hopping pattern 405 or beam hopping pattern 410.

As indicated above, FIG. 4 is provided as an example. Other examples may differ from what is described with respect to FIG. 4.

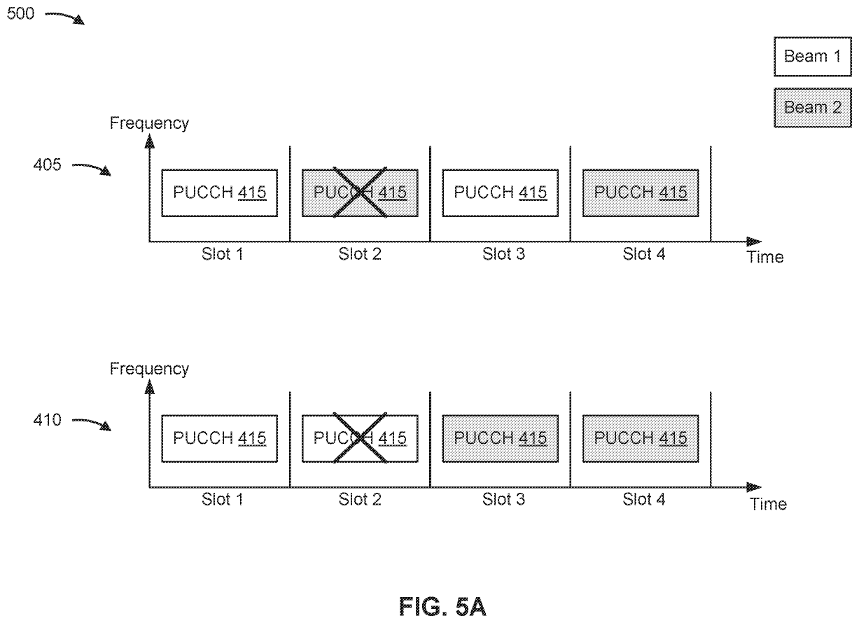

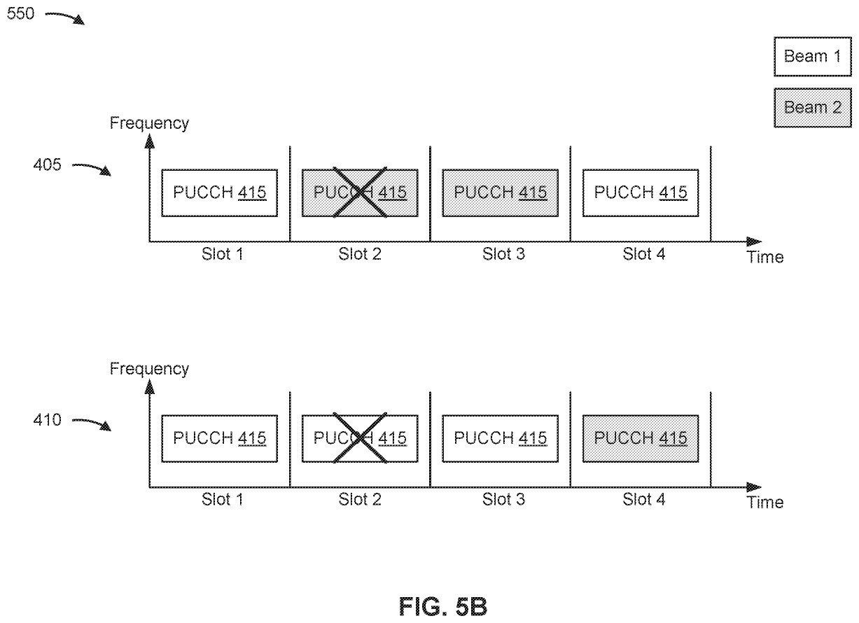

FIG. 5A is a diagram illustrating an example 500 of beam hopping for repetitions in a PUCCH resource, in accordance with various aspects of the present disclosure. In particular, FIG. 5A shows the beam hopping pattern 405 and the beam hopping pattern 410 for transmitting repetitions in the PUCCH resource 415 in multiple slots, as described in connection with FIG. 4. In the example 500, four repetitions are configured for the PUCCH resource 415. However, in some aspects, a different quantity of repetitions may be configured for the PUCCH resource 415, such as two repetitions or eight repetitions.

In some aspects, the UE 120 may not transmit a particular repetition that is scheduled to be transmitted in the PUCCH resource 415 in a slot. For example, the UE 120 may not transmit the repetition in the slot when the repetition has a potential collision with, or overlaps with, another PUCCH communication that is to be transmitted by the UE 120 in the slot. In this case, in some aspects, the pattern of repetitions of the first set (using Beam 1) and repetitions of the second set (using Beam 2) is defined without regard to whether the repetition is transmitted.

As described above, according to the beam hopping pattern 405, repetitions from the first set and the second set are cyclically mapped to the PUCCH resource 415 in multiple slots. Accordingly, repetitions of the first set (using Beam 1) are mapped to Slot 1 and Slot 3, and repetitions of the second set (using Beam 2) are mapped to Slot 2 and Slot 4, without regard to whether a particular repetition is transmitted by the UE 120. For example, as shown, the cyclic mapping pattern of the repetitions is unaffected when Slot 2 is not used to transmit a repetition.

As described above, according to the beam hopping pattern 410, repetitions from the first set and the second set are sequentially mapped to the PUCCH resource 415 in multiple slots. Accordingly, repetitions of the first set (using Beam 1) are mapped to Slot 1 and Slot 2, and repetitions of the second set (using Beam 2) are mapped to Slot 3 and Slot 4, without regard to whether a particular repetition is transmitted by the UE 120. For example, as shown, the sequential mapping of the repetitions is unaffected when Slot 2 is not used to transmit a repetition.

As indicated above, FIG. 5A is provided as an example. Other examples may differ from what is described with respect to FIG. 5A.

FIG. 5B is a diagram illustrating an example 550 of beam hopping for repetitions in a PUCCH resource, in accordance with various aspects of the present disclosure. In particular, FIG. 5B shows the beam hopping pattern 405 and the beam hopping pattern 410 for transmitting repetitions in the PUCCH resource 415 in multiple slots, as described in connection with FIG. 4. In the example 550, four repetitions are configured for the PUCCH resource 415. However, in some aspects, a different quantity of repetitions may be configured for the PUCCH resource 415, such as two repetitions or eight repetitions.

In some aspects, the UE 120 may not transmit a particular repetition that is scheduled to be transmitted in the PUCCH resource 415 in a slot, as described in connection with FIG. 5A. In this case, in some aspects, the pattern of repetitions of the first set (using Beam 1) and repetitions of the second set (using Beam 2) is defined with regard to whether the repetition is transmitted.

As described above, according to the beam hopping pattern 405, repetitions from the first set and the second set are cyclically mapped to the PUCCH resource 415 in multiple slots. For example, repetitions of the first set (using Beam 1) are mapped to Slot 1 and Slot 4, and the repetition of the second set that is to be transmitted (using Beam 2) is mapped to Slot 3, when Slot 2 is not used to transmit a repetition. That is, the repetitions from the first set and the second set are cyclically mapped to the PUCCH resource 415 in the slots in which repetitions are actually transmitted.

As described above, according to the beam hopping pattern 410, repetitions from the first set and the second set are sequentially mapped to the PUCCH resource 415 in multiple slots. For example, repetitions of the first set (using Beam 1) are mapped to Slot 1 and Slot 3, and the repetition of the second set that is to be transmitted (using Beam 2) is mapped to Slot 4, when Slot 2 is not used to transmit a repetition. That is, the repetitions from the first set and the second set are sequentially mapped to the PUCCH resource 415 in the slots in which repetitions are actually transmitted.

In some aspects, whether a pattern of repetitions is defined with regard to whether a particular repetition is transmitted is indicated via RRC signaling. For example, the BS 110 may transmit, and the UE 120 may receive, an RRC configuration that indicates whether a pattern of repetitions is defined with regard to whether a particular repetition is transmitted.

As indicated above, FIG. 5B is provided as an example. Other examples may differ from what is described with respect to FIG. 5B.

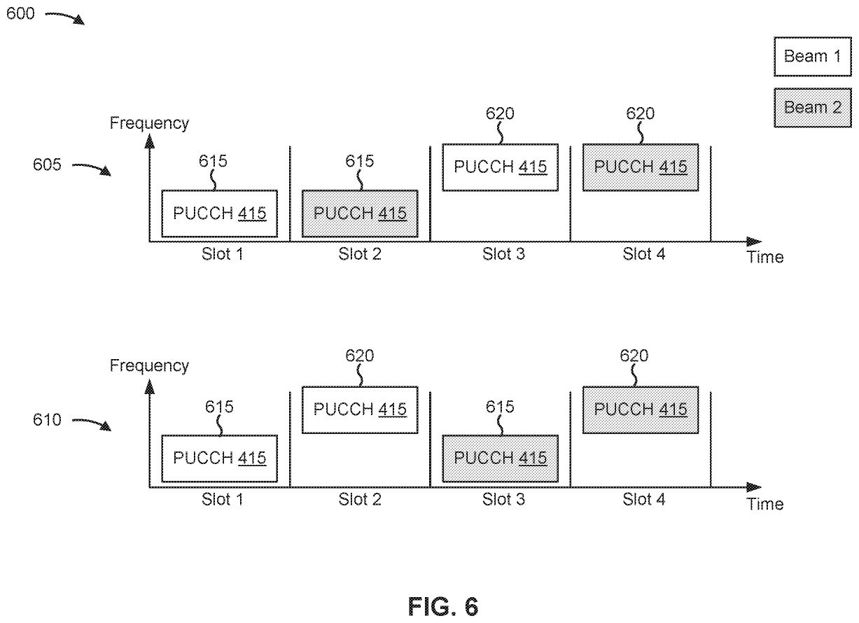

FIG. 6 is a diagram illustrating an example 600 of beam hopping for repetitions in a PUCCH resource, in accordance with various aspects of the present disclosure. In particular, FIG. 6 shows a beam and frequency hopping pattern 605 and a beam and frequency hopping pattern 610 for transmitting repetitions in a PUCCH resource 415 in multiple slots. In the example 600, four repetitions are configured for the PUCCH resource 415. However, in some aspects, a different quantity of repetitions may be configured for the PUCCH resource 415, such as two repetitions or eight repetitions.

As shown in FIG. 6, repetitions of the first set (using Beam 1) may use a first frequency hop 615 and a second frequency hop 610, and repetitions of the second set (using Beam 2) may use the first frequency hop 615 and the second frequency hop 620. The frequency hops may be inter-slot frequency hops. Moreover, the UE 120 may communicate using beam hopping and frequency hopping, for example, when an RRC parameter interSlotFrequencyHopping is enabled for the PUCCH resource 415.

As shown by beam and frequency hopping pattern 605, repetitions of the first set and the second set may be cyclically mapped to the PUCCH resource 415 in multiple slots, as described in connection with FIG. 4. Accordingly, the first frequency hop 615 and the second frequency hop 620, for repetitions of the first set (using Beam 1), are in non-consecutive slots, and the first frequency hop 615 and the second frequency hop 620, for repetitions of the second set (using Beam 2), are in non-consecutive slots. For example, as shown, a first repetition in Slot 1 may use Beam 1 and the first frequency hop 615, a second repetition in Slot 2 may use Beam 2 and the first frequency hop 615, a third repetition in Slot 3 may use Beam 1 and the second frequency hop 620, and a fourth repetition in Slot 4 may use Beam 2 and the second frequency hop 620.

As shown by beam and frequency hopping pattern 610, repetitions of the first set and the second set may be sequentially mapped to the PUCCH resource 415 in multiple slots, as described in connection with FIG. 4. Accordingly, the first frequency hop 615 and the second frequency hop 620, for repetitions of the first set (using Beam 1), are in consecutive slots, and the first frequency hop 615 and the second frequency hop 620, for repetitions of the second set (using Beam 2), are in consecutive slots. For example, as shown, a first repetition in Slot 1 may use Beam 1 and the first frequency hop 615, a second repetition in Slot 2 may use Beam 1 and the second frequency hop 620, a third repetition in Slot 3 may use Beam 2 and the first frequency hop 615, and a fourth repetition in Slot 4 may use Beam 2 and the second frequency hop 620.

In some aspects, a pattern of beam and frequency hopping is configured for the UE 120 (e.g., via RRC signaling). For example, the BS 110 may transmit, and the UE 120 may receive, an RRC configuration that indicates the pattern that the UE 120 is to use. The pattern may be beam and frequency hopping pattern 605 or beam and frequency hopping pattern 610.

As indicated above, FIG. 6 is provided as an example. Other examples may differ from what is described with respect to FIG. 6.

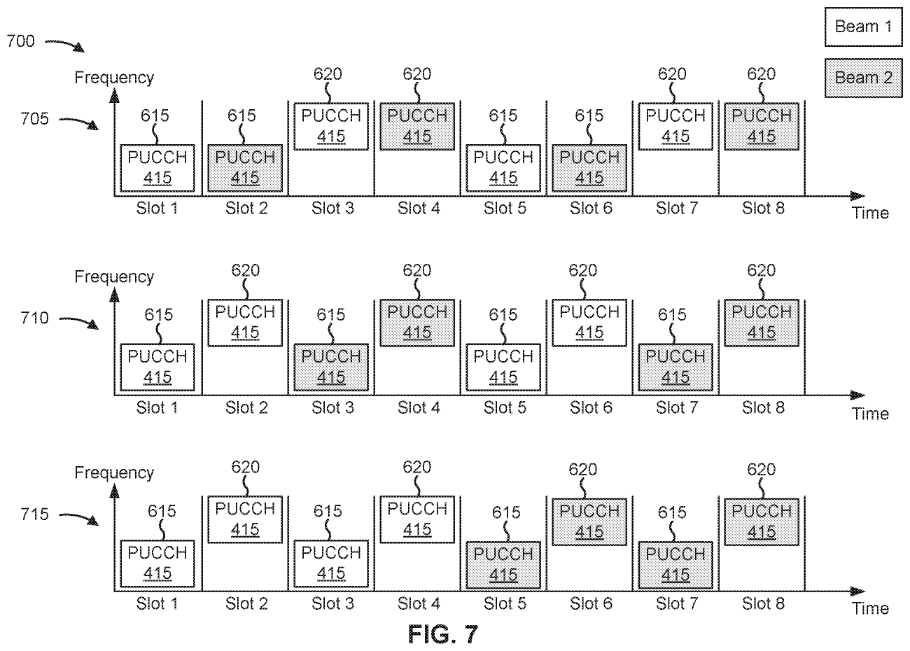

FIG. 7 is a diagram illustrating an example 700 of beam hopping for repetitions in a PUCCH resource, in accordance with various aspects of the present disclosure. In particular, FIG. 7 shows a beam and frequency hopping pattern 705, a beam and frequency hopping pattern 710, and a beam and frequency hopping pattern 715 for transmitting repetitions in a PUCCH resource 415 in multiple slots. In the example 700, eight repetitions are configured for the PUCCH resource 415. However, in some aspects, a different quantity of repetitions may be configured for the PUCCH resource 415, such as sixteen repetitions.

As shown in FIG. 7, repetitions of the first set (using Beam 1) may use the first frequency hop 615 and the second frequency hop 620, and repetitions of the second set (using Beam 2) may use the first frequency hop 615 and the second frequency hop 620. The frequency hops may be inter-slot frequency hops. Moreover, the UE 120 may communicate using beam hopping and frequency hopping, for example, when an RRC parameter interSlotFrequencyHopping is enabled for the PUCCH resource 415.

Beam and frequency hopping pattern 705 may use the beam and frequency hopping pattern 605 described in connection with FIG. 6. For example, Slots 1-4 may use a first repetition of the beam and frequency hopping pattern 605, and Slots 5-8 may use a second repetition of the beam and frequency hopping pattern 605. In other words, when eight repetitions are configured for the PUCCH resource 415, a beam and frequency hopping pattern used for a cyclic mapping of four repetitions may be repeated.

Beam and frequency hopping pattern 710 may use the beam and frequency hopping pattern 610 described in connection with FIG. 6. For example, Slots 1-4 may use a first repetition of the beam and frequency hopping pattern 610, and Slots 5-8 may use a second repetition of the beam and frequency hopping pattern 610. In other words, when eight repetitions are configured for the PUCCH resource 415, a beam and frequency hopping pattern used for sequential mapping of four repetitions may be repeated.

As shown by beam and frequency hopping pattern 715, repetitions of the first set and the second set may be sequentially mapped to the PUCCH resource 415 in multiple slots, as described in connection with FIG. 4. Accordingly, the first frequency hops 615 and the second frequency hops 620, for repetitions of the first set (using Beam 1), are in consecutive slots (e.g., the first frequency hops 615 and the second frequency hops 620 alternate in consecutive slots), and the first frequency hops 615 and the second frequency hops 620, for repetitions of the second set (using Beam 2), are in consecutive slots (e.g., the first frequency hops 615 and the second frequency hops 620 alternate in consecutive slots). For example, as shown, repetitions of the first set (e.g., a first half of the repetitions) may use Beam 1 in Slots 1-4 with inter-slot frequency hopping between the first frequency hop 615 and the second frequency hop 620, and repetitions of the second set (e.g., a second half of the repetitions) may use Beam 2 in Slots 5-8 with inter-slot frequency hopping between the first frequency hop 615 and the second frequency hop 620.

In some aspects, a pattern of beam and frequency hopping is configured for the UE 120 (e.g., via RRC signaling). For example, the BS 110 may transmit, and the UE 120 may receive, an RRC configuration that indicates the pattern that the UE 120 is to use. The pattern may be beam and frequency hopping pattern 705, beam and frequency hopping pattern 710, or beam and frequency hopping pattern 715.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where the UE (e.g., UE 120, and/or the like) performs operations associated with beam hopping for repetitions in a PUCCH resource.

As shown in FIG. 8, in some aspects, process 800 may include receiving an activation command to activate multiple spatial relations for a PUCCH resource that is to be used for transmitting repetitions of a communication in multiple slots (block 810). For example, the UE (e.g., using antenna 252, DEMOD 254, MIMO detector 256, receive processor 258, controller/processor 280, and/or the like) may receive an activation command to activate multiple spatial relations for a PUCCH resource that is to be used for transmitting repetitions of a communication in multiple slots, as described above.

As further shown in FIG. 8, in some aspects, process 800 may include transmitting the repetitions in the PUCCH resource in the multiple slots using the multiple spatial relations (block 820). For example, the UE (e.g., using controller/processor 240, transmit processor 220, TX MIMO processor 230, MOD 232, antenna 234, and/or the like) may transmit the repetitions in the PUCCH resource in the multiple slots using the multiple spatial relations, as described above.

Process 800 may include additional aspects, such as any single aspect or any combination of aspects described below and/or in connection with one or more other processes described elsewhere herein.

In a first aspect, the activation command is received via a MAC-CE.

In a second aspect, alone or in combination with the first aspect, the MAC-CE includes a bitmap for spatial relations, and multiple bits of the bitmap are set to indicate the multiple spatial relations that are to be activated.

In a third aspect, alone or in combination with one or more of the first and second aspects, the MAC-CE includes a first field that indicates a first spatial relation that is to be activated, and a second field that indicates a second spatial relation that is to be activated.

In a fourth aspect, alone or in combination with one or more of the first through third aspects, the MAC-CE includes a flag that is set when the second field is included in the MAC-CE.

In a fifth aspect, alone or in combination with one or more of the first through fourth aspects, a first set of the repetitions are to use a spatial domain filter used for reception or transmission of a reference signal indicated by a first spatial relation of the multiple spatial relations, and a second set of the repetitions are to use a spatial domain filter used for reception or transmission of a reference signal indicated by a second spatial relation of the multiple spatial relations.

In a sixth aspect, alone or in combination with one or more of the first through fifth aspects, repetitions of the first set are to use a first set of power control parameters indicated by the first spatial relation, and repetitions of the second set are to use a second set of power control parameters indicated by the second spatial relation.

In a seventh aspect, alone or in combination with one or more of the first through sixth aspects, repetitions of the first set alternate with repetitions of the second set.

In an eighth aspect, alone or in combination with one or more of the first through seventh aspects, the repetitions of the first set are even-indexed repetitions, and the repetitions of the second set are odd-indexed repetitions.

In a ninth aspect, alone or in combination with one or more of the first through eighth aspects, repetitions of the first set are consecutive, and repetitions of the second set are consecutive.

In a tenth aspect, alone or in combination with one or more of the first through ninth aspects, the repetitions of the first set are to occur before the repetitions of the second set.

In an eleventh aspect, alone or in combination with one or more of the first through tenth aspects, a pattern of repetitions of the first set and repetitions of the second set is indicated via RRC signaling.

In a twelfth aspect, alone or in combination with one or more of the first through eleventh aspects, a pattern of repetitions of the first set and repetitions of the second set is defined without regard to whether a particular repetition is transmitted.

In a thirteenth aspect, alone or in combination with one or more of the first through twelfth aspects, a pattern of repetitions of the first set and repetitions of the second set is defined with regard to whether a particular repetition is transmitted.

In a fourteenth aspect, alone or in combination with one or more of the first through thirteenth aspects, whether a pattern of repetitions of the first set and repetitions of the second set is defined with regard to whether a particular repetition is transmitted is indicated via RRC signaling.

In a fifteenth aspect, alone or in combination with one or more of the first through fourteenth aspects, repetitions of the first set use a first PUCCH power value and repetitions of the second set use a second PUCCH power value.

In a sixteenth aspect, alone or in combination with one or more of the first through fifteenth aspects, the first PUCCH power value is based at least in part on at least one of a first PL-RS, a first offset value, or a first closed loop index, and the second PUCCH power value is based at least in part on at least one of a second PL-RS, a second offset value, or a second closed loop index.

In a seventeenth aspect, alone or in combination with one or more of the first through sixteenth aspects, the first PUCCH power value is based at least in part on a first TPC accumulation function value, and the second PUCCH power value is based at least in part on a second TPC accumulation function value, when respective closed loop index values indicated by the first spatial relation and the second spatial relation are different.

In an eighteenth aspect, alone or in combination with one or more of the first through seventeenth aspects, respective closed loop index values indicated by the first spatial relation and the second spatial relation are different, and a TPC command indicated for the PUCCH resource is applied to the respective closed loop index values, the TPC command indicated for the PUCCH resource is applied to one of the respective closed loop index values, or respective TPC commands are indicated for the respective closed loop index values.

In a nineteenth aspect, alone or in combination with one or more of the first through eighteenth aspects, repetitions of the first set are to use a first frequency hop and a second frequency hop, and repetitions of the second set are to use the first frequency hop and the second frequency hop.

In a twentieth aspect, alone or in combination with one or more of the first through nineteenth aspects, the first frequency hop and the second frequency hop, for the repetitions of the first set, are in consecutive slots, and the first frequency hop and the second frequency hop, for the repetitions of the second set, are in consecutive slots.

In a twenty first aspect, alone or in combination with one or more of the first through twentieth aspects, the first frequency hop and the second frequency hop, for the repetitions of the first set, are in non-consecutive slots, and the first frequency hop and the second frequency hop, for the repetitions of the second set, are in non-consecutive slots.

In a twenty second aspect, alone or in combination with one or more of the first through twenty first aspects, a frequency hopping pattern for the repetitions of the first set and the repetitions of the second set is indicated via RRC signaling.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a BS, in accordance with various aspects of the present disclosure. Example process 900 is an example where the BS (e.g., BS 110, and/or the like) performs operations associated with beam hopping for repetitions in a PUCCH resource.

As shown in FIG. 9, in some aspects, process 900 may include determining, for a UE, multiple spatial relations that are to be activated for a PUCCH resource that is to be used by the UE for transmitting repetitions of a communication in multiple slots (block 910). For example, the BS (e.g., using controller/processor 240, and/or the like) may determine, for a UE, multiple spatial relations that are to be activated for a PUCCH resource that is to be used by the UE for transmitting repetitions of a communication in multiple slots, as described above.

As further shown in FIG. 9, in some aspects, process 900 may include transmitting an activation command to the UE to activate the multiple spatial relations for the PUCCH resource (block 920). For example, the BS (e.g., using controller/processor 240, transmit processor 220, TX MIMO processor 230, MOD 232, antenna 234, and/or the like) may transmit an activation command to the UE to activate the multiple spatial relations for the PUCCH resource, as described above.

Process 900 may include additional aspects, such as any single aspect or any combination of aspects described below and/or in connection with one or more other processes described elsewhere herein.

In a first aspect, the activation command is transmitted via a MAC-CE.

In a second aspect, alone or in combination with the first aspect, the MAC-CE includes a bitmap for spatial relations, and multiple bits of the bitmap are set to indicate the multiple spatial relations that are to be activated.

In a third aspect, alone or in combination with one or more of the first and second aspects, the MAC-CE includes a first field that indicates a first spatial relation that is to be activated, and a second field that indicates a second spatial relation that is to be activated.

In a fourth aspect, alone or in combination with one or more of the first through third aspects, the MAC-CE includes a flag that is set when the second field is included in the MAC-CE.

In a fifth aspect, alone or in combination with one or more of the first through fourth aspects, a first set of the repetitions are to use a spatial domain filter used for reception or transmission of a reference signal indicated by a first spatial relation of the multiple spatial relations, and a second set of the repetitions are to use a spatial domain filter used for reception or transmission of a reference signal indicated by a second spatial relation of the multiple spatial relations.

In a sixth aspect, alone or in combination with one or more of the first through fifth aspects, repetitions of the first set are to use a first set of power control parameters indicated by the first spatial relation, and repetitions of the second set are to use a second set of power control parameters indicated by the second spatial relation.

In a seventh aspect, alone or in combination with one or more of the first through sixth aspects, repetitions of the first set alternate with repetitions of the second set.

In an eighth aspect, alone or in combination with one or more of the first through seventh aspects, the repetitions of the first set are even-indexed repetitions, and the repetitions of the second set are odd-indexed repetitions.

In a ninth aspect, alone or in combination with one or more of the first through eighth aspects, repetitions of the first set are consecutive, and repetitions of the second set are consecutive.

In a tenth aspect, alone or in combination with one or more of the first through ninth aspects, the repetitions of the first set are to occur before the repetitions of the second set.

In an eleventh aspect, alone or in combination with one or more of the first through tenth aspects, a pattern of repetitions of the first set and repetitions of the second set is indicated via RRC signaling.

In a twelfth aspect, alone or in combination with one or more of the first through eleventh aspects, a pattern of repetitions of the first set and repetitions of the second set is defined without regard to whether a particular repetition is transmitted by the UE.

In a thirteenth aspect, alone or in combination with one or more of the first through twelfth aspects, a pattern of repetitions of the first set and repetitions of the second set is defined with regard to whether a particular repetition is transmitted by the UE.

In a fourteenth aspect, alone or in combination with one or more of the first through thirteenth aspects, whether a pattern of repetitions of the first set and repetitions of the second set is defined with regard to whether a particular repetition is transmitted by the UE is indicated via RRC signaling.

In a fifteenth aspect, alone or in combination with one or more of the first through fourteenth aspects, repetitions of the first set use a first PUCCH power value and repetitions of the second set use a second PUCCH power value.

In a sixteenth aspect, alone or in combination with one or more of the first through fifteenth aspects, the first PUCCH power value is based at least in part on at least one of a first PL-RS, a first offset value, or a first closed loop index, and the second PUCCH power value is based at least in part on at least one of a second PL-RS, a second offset value, or a second closed loop index.

In a seventeenth aspect, alone or in combination with one or more of the first through sixteenth aspects, the first PUCCH power value is based at least in part on a first TPC accumulation function value, and the second PUCCH power value is based at least in part on a second TPC accumulation function value, when respective closed loop index values indicated by the first spatial relation and the second spatial relation are different.

In an eighteenth aspect, alone or in combination with one or more of the first through seventeenth aspects, respective closed loop index values indicated by the first spatial relation and the second spatial relation are different, and a TPC command indicated for the PUCCH resource is to be applied by the UE to the respective closed loop index values, the TPC command indicated for the PUCCH resource is to be applied by the UE to one of the respective closed loop index values, or respective TPC commands are indicated for the respective closed loop index values.

In a nineteenth aspect, alone or in combination with one or more of the first through eighteenth aspects, repetitions of the first set are to use a first frequency hop and a second frequency hop, and repetitions of the second set are to use the first frequency hop and the second frequency hop.

In a twentieth aspect, alone or in combination with one or more of the first through nineteenth aspects, the first frequency hop and the second frequency hop, for the repetitions of the first set, are in consecutive slots, and the first frequency hop and the second frequency hop, for the repetitions of the second set, are in consecutive slots.

In a twenty first aspect, alone or in combination with one or more of the first through twentieth aspects, the first frequency hop and the second frequency hop, for the repetitions of the first set, are in non-consecutive slots, and the first frequency hop and the second frequency hop, for the repetitions of the second set, are in non-consecutive slots.

In a twenty second aspect, alone or in combination with one or more of the first through twenty first aspects, a frequency hopping pattern for the repetitions of the first set and the repetitions of the second set is indicated via RRC signaling.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving an activation command to activate multiple spatial relations for a physical uplink control channel (PUCCH) resource that is to be used for transmitting repetitions of a communication in multiple slots; and
transmitting the repetitions in the PUCCH resource in the multiple slots using the multiple spatial relations.

2. The method of claim 1, wherein the activation command is received via a medium access control control element (MAC-CE).

3. (canceled)

4. The method of claim 2, wherein the MAC-CE includes a first field that indicates a first spatial relation that is to be activated, and a second field that indicates a second spatial relation that is to be activated.

5. The method of claim 4, wherein the MAC-CE includes a flag that is set when the second field is included in the MAC-CE.

6. The method of claim 1, wherein a first set of the repetitions are to use a spatial domain filter used for reception or transmission of a reference signal indicated by a first spatial relation of the multiple spatial relations, and a second set of the repetitions are to use a spatial domain filter used for reception or transmission of a reference signal indicated by a second spatial relation of the multiple spatial relations.

7. (canceled)

8. The method of claim 6, wherein repetitions of the first set alternate with repetitions of the second set.

9. The method of claim 8, wherein the repetitions of the first set are even-indexed repetitions, and the repetitions of the second set are odd-indexed repetitions.

10. The method of claim 6, wherein repetitions of the first set are consecutive, and repetitions of the second set are consecutive.

11. The method of claim 10, wherein the repetitions of the first set are to occur before the repetitions of the second set.

12. The method of claim 6, wherein a pattern of repetitions of the first set and repetitions of the second set is indicated via radio resource control signaling.

13-15. (canceled)

16. The method of claim 6, wherein repetitions of the first set use a first PUCCH power value and repetitions of the second set use a second PUCCH power value.

17. The method of claim 16, wherein the first PUCCH power value is based at least in part on at least one of a first pathloss reference signal, a first offset value, or a first closed loop index, and the second PUCCH power value is based at least in part on at least one of a second pathloss reference signal, a second offset value, or a second closed loop index.

18. The method of claim 16, wherein the first PUCCH power value is based at least in part on a first transmit power control accumulation function value, and the second PUCCH power value is based at least in part on a second transmit power control accumulation function value, when respective closed loop index values indicated by the first spatial relation and the second spatial relation are different.

19. The method of claim 16, wherein respective closed loop index values indicated by the first spatial relation and the second spatial relation are different, and
wherein a transmit power control (TPC) command indicated for the PUCCH resource is applied to the respective closed loop index values.

20. The method of claim 6, wherein repetitions of the first set are to use a first frequency hop and a second frequency hop, and repetitions of the second set are to use the first frequency hop and the second frequency hop.

21. The method of claim 20, wherein the first frequency hop and the second frequency hop, for the repetitions of the first set, are in consecutive slots, and the first frequency hop and the second frequency hop, for the repetitions of the second set, are in consecutive slots.

22. The method of claim 20, wherein the first frequency hop and the second frequency hop, for the repetitions of the first set, are in non-consecutive slots, and the first frequency hop and the second frequency hop, for the repetitions of the second set, are in non-consecutive slots.

23. The method of claim 16, wherein respective closed loop index values indicated by the first spatial relation and the second spatial relation are different, and
wherein respective transmit power control (TPC) commands are indicated for the respective closed loop index values.

24. A method of wireless communication performed by a base station, comprising:
determining, for a user equipment (UE), multiple spatial relations that are to be activated for a physical uplink control channel (PUCCH) resource that is to be used by the UE for transmitting repetitions of a communication in multiple slots; and
transmitting an activation command to the UE to activate the multiple spatial relations for the PUCCH resource.

25. The method of claim 24, wherein the activation command is transmitted via a medium access control control element (MAC-CE).

26. (canceled)

27. The method of claim 25, wherein the MAC-CE includes a first field that indicates a first spatial relation that is to be activated, and a second field that indicates a second spatial relation that is to be activated.

28. (canceled)

29. The method of claim 24, wherein a first set of the repetitions are to use a spatial domain filter used for reception or transmission, by the UE, of a reference signal indicated by a first spatial relation of the multiple spatial relations, and a second set of the repetitions are to use a spatial domain filter used for reception or transmission, by the UE, of a reference signal indicated by a second spatial relation of the multiple spatial relations.

30. (canceled)

31. The method of claim 29, wherein repetitions of the first set alternate with repetitions of the second set.

32. (canceled)

33. The method of claim 29, wherein repetitions of the first set are consecutive, and repetitions of the second set are consecutive.

34. (canceled)

35. The method of claim 29, wherein a pattern of repetitions of the first set and repetitions of the second set is indicated via radio resource control signaling.

36-38. (canceled)

39. The method of claim 29, wherein repetitions of the first set use a first PUCCH power value and repetitions of the second set use a second PUCCH power value.

40-41. (canceled)

42. The method of claim 39, wherein respective closed loop index values indicated by the first spatial relation and the second spatial relation are different, and
wherein a transmit power control (TPC) command indicated for the PUCCH resource is to be applied by the UE to the respective closed loop index values.

43-45. (canceled)

46. The method of claim 39, wherein respective closed loop index values indicated by the first spatial relation and the second spatial relation are different, and
wherein respective transmit power control (TPC) commands are indicated for the respective closed loop index values.

47. A user equipment (UE) for wireless communication, comprising:
a memory; and
one or more processors operatively coupled to the memory, the one or more processors configured to:
receive an activation command to activate multiple spatial relations for a physical uplink control channel (PUCCH) resource that is to be used for transmitting repetitions of a communication in multiple slots; and
transmit the repetitions in the PUCCH resource in the multiple slots using the multiple spatial relations.

48. A base station for wireless communication, comprising:
a memory; and
one or more processors operatively coupled to the memory, the one or more processors configured to:
determine, for a user equipment (UE), multiple spatial relations that are to be activated for a physical uplink control channel (PUCCH) resource that is to be used by the UE for transmitting repetitions of a communication in multiple slots; and
transmit an activation command to the UE to activate the multiple spatial relations for the PUCCH resource.

49-52. (canceled)
